(19) United States
(12) Patent Application Publication
(10) Pub. No.: US 2008/0007149 A1
(43) Pub. Date: Jan. 10, 2008

(54) Foamable Element for Mutually Coupling of Multiple Components of a Lamp, and Lamp Assembly

(75) Inventors: Ralph Hubert Peters, Eindhoven (NL); Nicolas Gerardus Antonius Peeters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,983

(22) PCT Filed: Jun. 8, 2005
(86) PCT No.: PCT/IB05/51868

§ 371 Date: Dec. 4, 2006

(30) Foreign Application Priority Data
Jun. 10, 2004 (EP) 04102651.9

(51) Int. Cl. H01J 5/48; C08J 9/00; H01J 9/00

(52) U.S. Cl. 313/318.08; 445/23; 521/50.5

(57) ABSTRACT

The invention relates to a foamable element for mutual coupling of multiple components of a lamp. The invention also relates to a lamp assembly comprises at least two components of a lamp. The invention further relates to a method for mutually coupling multiple components of a lamp using said foamable element.

The invention relates to a foamable element for mutual coupling of multiple components of a lamp. The invention also relates to a lamp assembly comprises at least two components of a lamp. The invention further relates to a method for mutually coupling multiple components of a lamp using said foamable element.

In the art it is known to manufacture lamp assemblies, such as fluorescent tubes, incandescent (low-energy) bulbs and discharge lamps, by affixing multiple components by a thermosetting cement. This cement, however, has several drawbacks. The known cements have short shelf lives because of the need for solvents like trioxane or hexamethylenetetramine and other reactive components like aldehydes, ammonia, or metal hydroxides. Secondly, accurate application of these cements is difficult, and as a result, a relatively large amount of cement must be used to adhere a glass lamp to a metal base. To eliminate these drawbacks of the known cement the manufacturing process of these lamp assemblies can be improved by using a foamable element as disclosed in the international application WO03/014203. By heating the lamp assembly for a certain time the components are heated to a sufficient temperature to make the foamable element expand thereby securely affixing the lamp components. Although it is founded that application of the foamable element achieves significantly improved results with respect to application of the thermosetting cement, the known foamable element also has a major drawback. Drawback of the method using a conventional foamable element is that the lamp assembly must be positioned in an atmosphere having an increasing temperature to let the foamable material expand thereby mutually coupling the lamp components neighbouring the foamed material. This overall heating of the lamp assembly can lead to deformations and other damaging of certain lamp components sensitive for this elevated temperature during foaming. Moreover, exposure of these sensitive component to the foaming temperature during a certain time can reduce the life span of these components significantly.

It is therefore an object of the invention to provide an improved foamable element which does not require significant heating of neighbouring lamp components to be coupled by the foamable element during foaming.

This object can be achieved by a foamable element according to the preamble, characterized in that the foamable element is provided with heating means for heating said foamable element. By providing the foamable element with heating means the heat required to expand the foamable element can be generated in the direct area of the foamable element. In this way position-selective and direct heating of the foamable element can be achieved, without seriously heating up other parts of the lamp assembly. Although the components neighbouring the foamable element will be heated during operation of the heating means, the heat absorption of these components will be significantly small compared to the heat absorption during the known foaming method with the known foamable element, resulting in an improved life span and maintenance of the structure and material related properties of these neighbouring components. Moreover, the overall amount of energy required to heat up the foamable element sufficiently is relatively less compared to the amount of energy required according to the method known in the art. Thus, by applying the heating means in (or directly on) the foamable element the foamable element can be heated relatively efficiently and effectively without affecting other lamp components. Since the foamable element can be heated in a position-selective way, it is a further advantage that the freedom of choice as regards material, shape and format of the neighbouring lamp components is many times greater than the freedom offered by the state of the art.

It is imaginable that the heating means are provided with coupling means to allow electrical coupling the heating means to an external energy source, such as an electricity grid. However, in a preferred embodiment said heating means are adapted to produce heat upon absorption of electromagnetic radiation. In this advantageous embodiment the heating means can be activated wireless and relatively effectively by simply placing the heating means in a electromagnetic field with preferably specific characteristics. By absorption of the electromagnetic radiation by the heating means the absorbed electromagnetic field energy will be converted into heat which is subsequently absorbed by the foamable element. This heat absorption will lead to a foaming (expanding) of the yet unfoamed element.

Preferably, said heating means comprise at least one ring-shaped element. Said ring-shaped element can be formed by a circular ring, but it is also imaginable to apply e.g. a triangular or rectangular ring. A ring-shaped design of said heating means generates a relatively large freedom of choice as regards material, shape and format of both the neighbouring lamp components and said foamable element. Moreover, due to this improved freedom of design, it is advantageous to apply ring-shaped heating means, since in this way the outer edge(s) of the foamable element can be heated relatively intensively. These outer edge(s) are found of major importance to realise a solid, stable and lasting mutual coupling of two or more components of a lamp.

In a preferred embodiment said heating means form at least one conductive circuit. A conductive circuit is commonly relatively suitable to absorb relatively large amounts of energy, which can subsequently be converted to heat to be absorbed by the foamable element. Metals, like for example copper, can be used to generate the conductive properties of the circuit. It is not necessary the that conductive circuit of the heating means is formed by a single physical element. This circuit, and therefore the heating means, can also be formed by controlled distribution of conductive (metal) particles in the foamable element. In this embodiment the heating means can be fully integrated in the foamable element. Commonly, the conductive circuit is formed by the abovementioned ring-shaped element, like for example a metal ring.

In another preferred embodiment the heating means are embedded in said foamable element. As mentioned above the heating means can be formed by multiple metal particles distributed (uniformly) in the foamable element, but can also be formed by for example a ring embedded in said foamable element at least partially. It is not required to embed the heating means completely in the foamable element, but preferably the heating means are surrounded substantially by the foamable element, since the heat transfer from the heating means to the foamable element can be maximised in this way.

The foamable element per se is preferably ring-shaped. Since the outline of most lamp components is ring-shaped (circularly, triangularly, et cetera), it is advantageous to apply a ring-shaped foamable element to be able to optimise the mutual coupling of the lamp components.

In a preferred embodiment the foamable element is adapted to expand substantially in a radial direction. Commonly, lamp components are assembled by firstly mutual overlapping these components partially, and secondly affixing this telescopic orientation of the components. By positioning the foamable element in the space between the overlapping parts of the components, a relatively stable and solid coupling of the components can be achieved by radial expansion of the foamable element, thereby engaging the components to be coupled under a certain bias.

The foamable element can be made of any material adapted to foam upon heating, but preferably the foamable element comprises a blowing agent and a copolymer wherein the copolymer is selected from the group consisting of ethylene vinyl acetate (EVA), ethylene methyl acrylate (EMA), ethylene butyl acrylate, ethylene ethyl acrylate, ethylene methacrylic acid and mixtures thereof. These compositions have foaming temperatures in the range of the intended application and can withstand prolonged use at elevated temperatures.

The invention also relates to a lamp assembly according to the preamble, characterized in that said components are mutually coupled by at least one foamable component as described above. Preferably, said components are selected from the group consisting of a lamp base, a burner, a cover for said burner, and a bulb (sleeve). Beside these components it is also conceivable to couple other lamp components by one of multiple foamable elements.

The invention further relates to a method for mutually coupling multiple components of a lamp using a foamable element as described above, comprising the steps of: a) assembling at least two components and at least one interposing foamable element, and b) making the heating means heat said foamable element, thereby expanding said foamable element and affixing said components. Preferably in step a) the foamable element is positioned between the interior surface of one component and the exterior surface of a neighbouring component. In another preferred embodiment in step b) electromagnetic radiation is generated to heat up the heating means being sensitive for this radiation. In a particular preferred embodiment the radiation has a frequency between 20 kHz and 1 MHz.

The invention will be illustrated by way of the following non-restrictive examples.

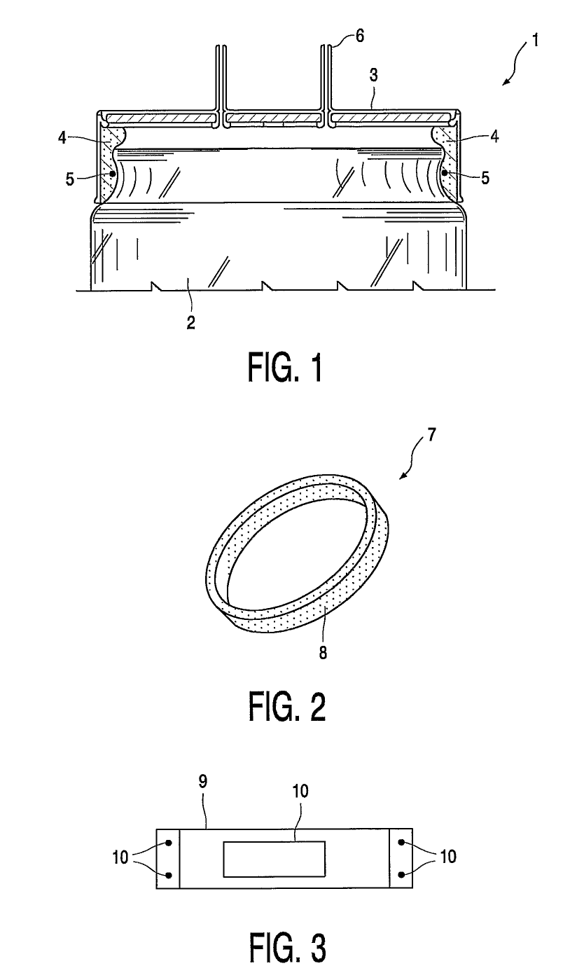

FIG. 1 shows a cross-sectional view of a lamp assembly according to the invention.

FIG. 2 shows a perspective view of an embodiment of an unfoamed element according to the present invention.

FIG. 3 shows a cross-sectional view of another embodiment of a foamable element according to the invention.

FIG. 1 shows a cross-sectional view of a lamp assembly 1 according to the invention. The lamp assembly 1 comprises a glass tube 2 which is securely affixed in a base 3 by means of a foamed (and cured) element 4. The foamed element 4 is provided with a metal ring 5 to improve the foaming process of the element 4. The metal ring 5 is sensitive for electromagnetic radiation, preferably electromagnetic radiation with a relatively high frequency. The metal ring 5 will absorb this radiation and will convert this energy to produce heat which is subsequently transferred to the element 4 to make it foam. Optionally, a small amount of adhesive can be used to secure the coupling of the glass tube 2 and the base 3. The base 3 is provided with electrical contacts 6 to connect the lamp assembly 1 to an electrical power source. In this example a part of a luminescent tube is shown. However, it is also conceivable to apply the foamed element 4 in other types of lamps, wherein even more than two, as for example three or four, components can be mutually coupled.

FIG. 2 shows a perspective view of an embodiment of an unfoamed element 7 according to the present invention. The element 7 is ring-shaped and is substantially formed by a EVA or EMA based copolymer composition. This composition is provided with a blowing agent to effect foaming and expansion of the foamable composition at an activation temperature from about 120° C. to about 250° C. Suitable blowing agents will normally include azodicarbonamide and benzenesulfonyl hydrazide. Examples of suitable blowing agents are disclosed in the international application WO 03/014203. The foamable composition further comprises metal particles 8 which are distributed uniformly through the copolymer composition. The distribution of the metal particles 8 is such that the particles form a conductive circuit suitable for absorbing electromagnetic radiation to sufficiently heat up the ring-shaped element 7.

FIG. 3 shows a cross-sectional view of another embodiment of a foamable element 9 according to the invention. The foamable element 9 can have a circular ring-shaped or rectangular-shaped design. In this example, the foamable element 9 comprises four rectangular-shaped conductive rings 10 suitable for heating up the foamable element 9 to make it foam. The conductive rings 10 can either have a 2D flattened geometry or a 3D curved geometry. The positioning of the conductive rings 10 in the foamable element 9 is such that in particular the most critical regions of the foamable element 9, id est regions of the foamable element 9 which are highly important to establish a solid coupling of lamp parts, can be heated meticulously and intensively.

It will be apparent that the invention is not limited to the exemplary embodiments shown and described here, but that numerous variants, which will be obvious to the skilled person in the field, are possible within the scope of the appended claims. The mere fact that certain measures are recited in mutually different dependent claims does not indicate that a combination of these measures cannot be used to advantage.

1. A foamable element for mutually coupling multiple components of a lamp, characterized in that the foamable element is provided with heating means for heating said foamable element.

2. A foamable element as claimed in claim 1, characterized in that said heating means are adapted to produce heat upon absorption of electromagnetic radiation.

3. A foamable element as claimed in claim 1, characterized in that said heating means comprise at least one ring-shaped element.

4. A foamable element as claimed in claim 1, characterized in that said heating means form at least one conductive circuit.

5. A foamable element as claimed in claim 1, characterized in that the heating means are manufactured at least partially of metal.

6. A foamable element as claimed in claim 1, characterized in that the heating means are embedded in said foamable element.

7. A foamable element as claimed in claim 6, characterized in that the heating means are substantially surrounded by the foamable element.

8. A foamable element as claimed in claim 1, characterized in that the foamable element is ring-shaped.

9. A foamable element as claimed in claim 1, characterized in that the foamable element is adapted to expand substantially in a radial direction.

10. A foamable element as claimed in claim 1, characterized in that the foamable element comprises a blowing agent and a copolymer, wherein the copolymer is selected from the group consisting of ethylene vinyl acetate, ethylene methyl acrylate, ethylene butyl acrylate, ethylene ethyl acrylate, ethylene methacrylic acid and mixtures thereof.

11. A lamp assembly comprising at least two components of a lamp, characterized in that said components are mutually coupled by at least one foamable component as claimed in claim 1.

12. A lamp assembly as claimed in claim 11, characterized in that said components are selected from the group consisting of a lamp base, a burner, a cover for said burner, and a bulb.

13. A method of mutually coupling multiple components of a lamp, using a foamable element as claimed in claim 1, the method comprising the steps of:
assembling at least two components and at least one interposing foamable element, and
causing the heating means to heat said foamable element, thereby expanding said foamable element and affixing said components.

14. A method as claimed in claim 13, characterized in that, in step a), the foamable element is positioned between the interior surface of one component and the exterior surface of a neighboring component.

15. A method as claimed in claim 13, characterized in that, in step b), electromagnetic radiation is generated to heat the heating means which are sensitive to this radiation.

16. A method as claimed in claim 15, characterized in that the radiation has a frequency between 20 kHz and 1 MHz.
